(19) United States
(12) Patent Application Publication
(10) Pub. No.: US 2019/0234311 A1
(43) Pub. Date: Aug. 1, 2019

(54) THERMAL INSULATION FOR FLUID CARRYING COMPONENTS

(71) Applicant: PRATT & WHITNEY CANADA CORP., Longueuil (CA)

(72) Inventors: Oleg MORENKO, Oakville (CA); Aleksandar KOJOVIC, Oakville (CA)

(21) Appl. No.: 15/882,157

(22) Filed: Jan. 29, 2018

(51) Int. Cl. F02C 7/24; F02C 3/06; F02C 7/22; F02K 3/06

(52) U.S. Cl. CPC F02C 7/24; F02C 3/06; F02C 7/222; F02K 3/06; F05D 2240/35; F05D 2230/31; F05D 2230/20; F05D 2260/231; F05D 2220/323

(57) ABSTRACT

A thermally insulated fluid carrying component, such as fuel manifold, comprises a monolithic body having an internal insulation cavity extending along at least one fluid passage to be shielded from a heat source. Additive manufacturing or metal injection molding technologies can be used to optimise the relative positioning of the insulation cavity and the fuel passage as well as the shape of the monolithic body for thermal insulation purposes.

### TECHNICAL FIELD

The application relates generally to fluid carrying components and, more particularly, to thermal insulation for such components.

### BACKGROUND OF THE ART

Fluid carrying components, such as gas turbine engine fuel manifolds, operating in hot temperature environments require thermal insulation. Indeed, when exposed to heat, hydrocarbons, such as jet fuel, may form carbonaceous deposits on inside surfaces of the fluid carrying component. The deposits may accumulate to the point where they restrict the flow of fuel, resulting in damage or operational failure.

Fuel or oil lines in gas turbine engines typically have a foil insulation wrapped around the exterior of the line to insulate the line and shield the fluid in the line from exposure to heat. However, such a heat shielding method may not be practical for fluid carrying components having more complex geometries, such as bearing housings and internal fuel manifolds. Also, the installation and maintenance of such heat shielding can be costly. In addition, such heat shielding is not always as effective as desired, requiring additional, costly measures to insure the fluid carrying components remain clear of deposits. An improved heat-shielded method and heat shielded fluid carrying component is desired.

### SUMMARY

In one aspect, there is provided a fuel manifold adapted to be mounted about an axis of a gas turbine engine, the fuel manifold comprising: a monolithic body having an inner circumferential surface and an outer circumferential surface configured to extend about the axis of the gas turbine engine, at least one fuel channel integrally formed in the monolithic body, at least one insulation cavity integrally formed in the monolithic body and forming a thermal barrier radially between the at least one fuel channel and at least one of the inner circumferential surface and the outer circumferential surface.

In another aspect, there is provided a method of manufacturing a thermally insulated fluid carrying component comprising: using metal injection molding (MIM) or additive manufacturing (AM) to create a body having an internal insulation cavity extending along at least one fluid passage to be shielded from a heat source, the internal insulation cavity and the at least one fluid passage being eccentric to one another and to a centerline of the body.

In a further aspect, there is provided a method for heat shielding a fuel manifold of a gas turbine engine, the method comprising: using metal injection molding (MIM) or additive manufacturing (AM) to create an insulation cavity in an arcuate body having at least one fuel channel interconnecting a plurality of nozzle tips distributed along a length of the arcuate body, the insulation cavity having at least one portion thereof disposed radially inward of the at least one fuel channel relative to a center of curvature of the arcuate body to form a thermal barrier along a radially inner side of the at least one fuel channel.

In a still further aspect, there is provided a gas turbine engine fuel manifold comprising: an arcuate body; nozzle seats defined in a face of the arcuate body for receiving corresponding nozzle tips, the nozzle seats being distributed along a length of the arcuate body; at least one fuel channel integrally formed in the arcuate body, the at least one fuel channel being fluidly connected to the nozzle tips; and an insulation cavity integrally formed in the arcuate body between an outer surface of the arcuate body and the at least one fuel channel.

### DESCRIPTION OF THE DRAWINGS

Reference is now made to the accompanying figures in which:

FIG. 1 is a schematic cross-sectional view of a gas turbine engine;

FIG. 2 is a cross-section view of the combustor section and illustrating a segmented internally mounted fuel manifold;

FIG. 3 is a cross-section view of one of the segment of the segmented fuel manifold;

FIG. 4 is a longitudinal cross-section of a portion of one of the manifold segment and illustrating the converging nozzle cross-section profile of the fuel channels that can be used to increase fuel flow velocity; and

FIG. 5 is a cross-section of a fuel manifold body in accordance with another embodiment.

### DETAILED DESCRIPTION

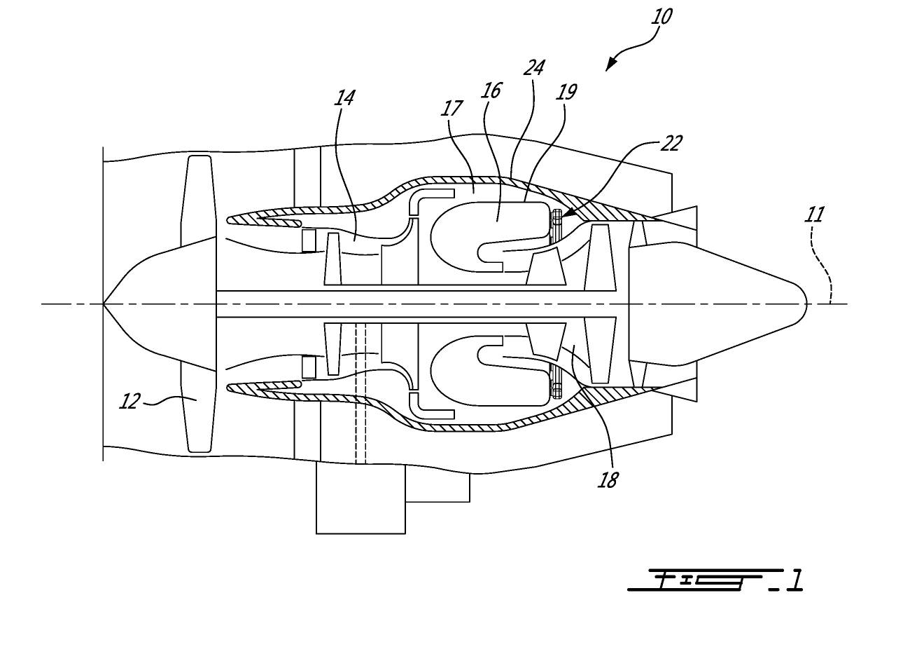

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor section 16 in which the compressed air is mixed with fuel and ignited for generating an annular stream of hot combustion gases, and a turbine section 18 for extracting energy from the combustion gases.

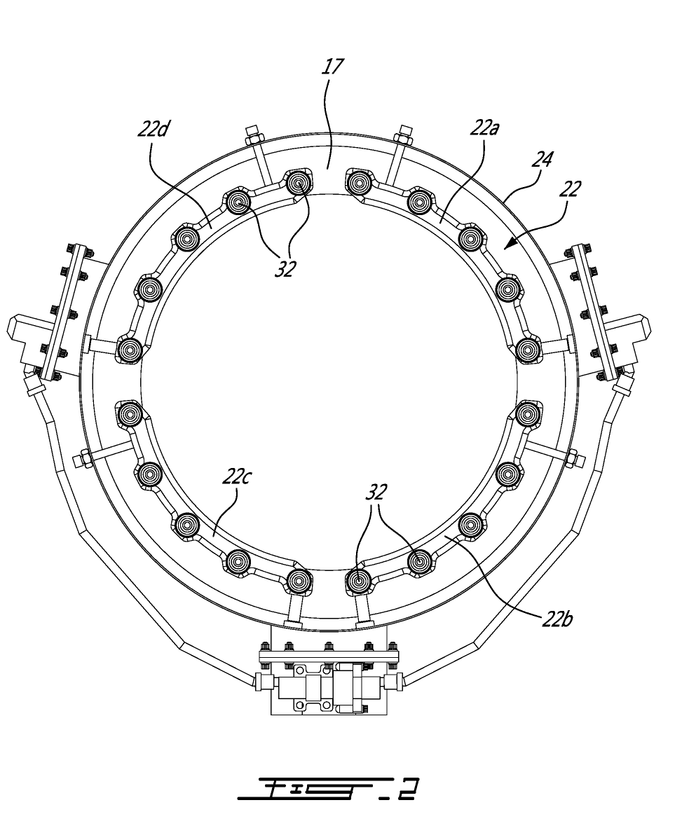

The combustor section 16 comprises a combustor having an annular combustor shell 19 concentrically mounted about the engine central axis 11 in a plenum 17 circumscribed by a gas generator case 24. The combustor section 16 further comprises a fuel manifold assembly 20 for supplying fuel to the combustor. As can be appreciated from FIG. 2, the fuel manifold assembly 20 comprises an annular fuel manifold 22 mounted in the plenum 17 inside the gas generator case 24 of the engine 10.

Such an internal fuel manifold 22 flowing liquid fuel and operating in hot environments like plenum 17 are susceptible to fuel vanishing and coking. Coking can lead to decreased flow capacity of the manifold and decreased of fuel delivery. To manage the temperature of the fuel in the manifold 22 and prevent coking, proper thermal insulation is needed. Also, it can be desirable to minimize the time of “travel” of the fuel in the internal fuel manifold 22 so as to reduce fuel heat gain.

As shown in FIG. 2, the internal fuel manifold 22 can be segmented. Comparing to a conventional internal fuel manifold (full ring design), the segmented configuration is expected to demonstrate better durability due to a reduced maximum fuel temperature inside the segments (less fuel “travel” time required in order to reach the last fuel injection point). In the illustrated example, the manifold 22 consists of a plurality (4 in the illustrated example) of rigid manifold ring segments 22a, 22b, 22c and 22d. Each manifold ring segment 22a, 22b, 22c, 22d is herein described as a non-limiting example of a thermally insulated fluid carrying component, which can be manufactured using metal injection molding (MIM) or additive manufacturing (AM) technologies for creating optimized heat shielding configurations and manifold segment shapes.

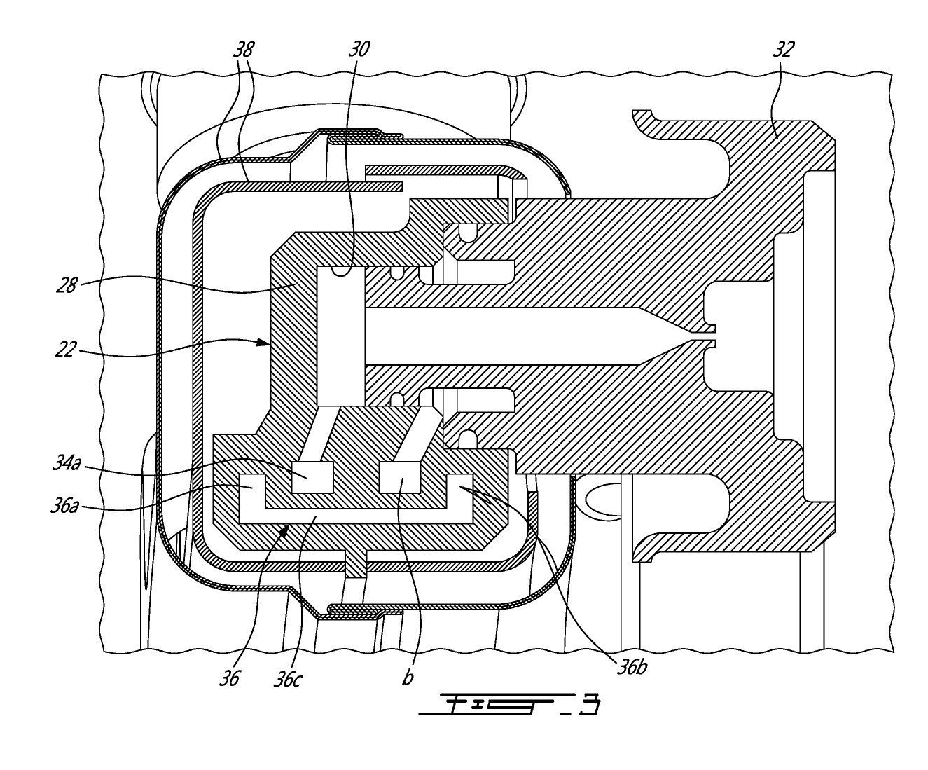

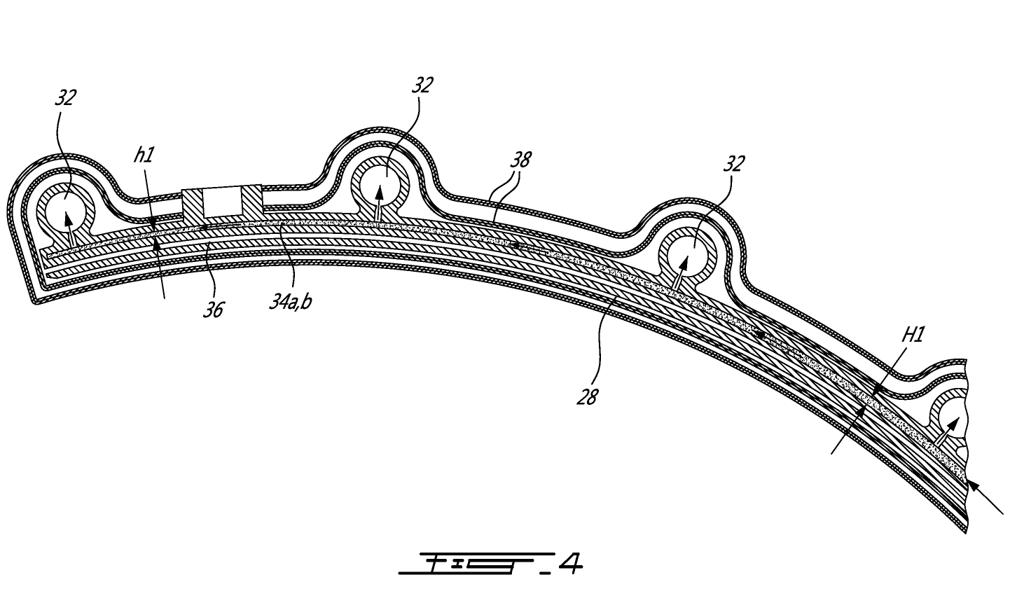

Now referring concurrently to FIGS. 2 and 3, it can be seen that each ring segment 22a, 22b, 22c, 22d has a MIM or AM created homogenous monolithic body 28 having an arcuate elongated shape defining a ring segment for generally spanning one quadrant of the annular combustion chamber of the gas turbine engine combustor. The cross-sectional shape of the body 28 can be optimized for weight and heat shielding purposes. Circumferentially spaced-apart fuel nozzle seats 30 are integrally formed in the front face of the body 28 for receiving corresponding nozzle tips 32. Additional material can be provided at each injection point for accommodating the nozzle tips 32. As shown in FIG. 3, this provides for a relatively complex asymmetric cross-sectional shape, which can be optimized for better weight and heat management. The nozzle tips 32 can be brazed or otherwise suitably secured in their respective seats 30 on the body 28. The nozzle tips 32 are fed by at least one fuel passage extending through the body 28 along the length thereof. As shown in FIG. 4, the at least one passage follows the longitudinal curvature of the body 28 in which it is integrally formed. In the example illustrated in FIG. 3, the at least one fuel passage comprises a primary fuel channel 34a and a secondary fuel channel 34b. The primary fuel channel 34a and the secondary fuel channel 34b are laterally spaced-apart and extend side-by-side along an arc of circle from one end of the body 28 to the next. In the illustrated example, the primary and secondary fuel channels 34a, 34b are spaced radially inwardly from the nozzle tips 32 relative to the engine axis 11. The location of the primary and secondary fuel channels 34a, 34b can be optimized for fuel flow distribution purposes and heat management purposes. In the illustrated example, it can be seen that the fuel channels 34a, 34b are eccentrically disposed in the body (they are offset from the centerline of the body 28).

The primary and secondary fuel channels 34a, 34b can have various cross-sectional shapes. In the illustrated embodiment, both primary and secondary fuel channels 34a, 34b have a rectangular cross-sectional shape. The cross-sectional shape of the channels is selected to obtain the desired fuel flow properties. It is understood that the shape of the primary fuel channel 34a could be different from that of the secondary fuel channel 34b could be different. Also they could have the same shape but different cross-sectional flow areas. Referring to FIG. 4, it can be appreciated that the fuel channels 34a, 34b can have a variable cross-sectional area along at least a portion of the length thereof. In the illustrated example, the channels 34a, 34b are configured to accelerate the flow of fuel (and eliminate unnecessary extra fuel mass flow to the subsequent nozzle tips) in order to minimize the time required for the fuel to reach the last nozzle tip of each manifold segment and, thus, minimize fuel heat gain. For instance, the fuel channels 34a, 34b may have a convergent nozzle profile along a full length thereof (or along only a portion of its length) in a direction of flow. In the illustrated example, the height of the channels 34a, 34b gradually decreases from a height H1 at an upstream end of the body 28 to a height h1 at the downstream of the body 28. According to another embodiment, the channels 34a, 34b could narrow down from a wide diameter to a smaller diameter in the direction of the flow. The cross-sectional variation in the fuel channels 34a, 34b could be configured to accelerate the flow only in certain areas where there is higher potential for heat pick up. In this way, a more uniform temperature distribution can be maintained throughout the body 28 of each manifold segment 22a, 22b, 22c 22d. Also, an optimized cross section shape (which may vary along the channel, not just simple convergent channel profile) can help to minimize hydraulic losses and reduce heat pick up.

Referring back to FIG. 3, it can be seen that the body 28 further has an internal insulation cavity 36 to form a thermal barrier between the fuel channels 34a, 34b and the plenum 17. The insulation cavity 36 is disposed radially between an inner circumferential surface of the body 28 and the fuel channels 34a, 34b with respect to the engine axis 11. The insulation cavity 36 transversally spans the fuel channels 34a, 34b and is, at least in some embodiments, co-extensive with the fuel channels 34a, 34b in a circumferential direction. In the illustrated embodiment, the insulation cavity 36 has a low profile and a generally U-shaped cross-section including first and second legs 36a, 36b extending radially outwardly from a opposed ends of an elongated base 36c. The primary and secondary fuel channels 34a, 34b are disposed between the first and second legs 36a, 36b of the insulation cavity 36. Accordingly, the insulation cavity 36 not only thermally shields the bottom of the fuel channels 34a, 34b (the radially inner face thereof) but also the front and rear sides thereof. Accordingly, the fuel channels 34a, 34b are thermally shielded on 3 out of 4 sides by the insulation cavity 36. With MIM or AM technologies, virtually any desired insulation cavity shapes can be created to appropriately thermally shield the fuel channels 34a, 34b at the locations where they need to protection. For instance, the leg 36a of the insulation cavity could extend along a major portion of the height of the body 28 behind the nozzle tips 32. Such an extended insulation cavity would provide an extra protection for the nozzle tip back side. The cross-sectional area of the insulation cavity 36 can also vary along its length. The insulation cavity 36 is strategically located in the body 28 to effectively thermally shield the fuel channels 34a, 34b. In the illustrated embodiment, both the insulation cavity 36 and the fuel channels 34a, 34b are eccentric relative to the body centerline. The use of MIM or AM allows to strategically designing the shape of the body 28, the fuel channels 34a, 34b and the insulation cavity 36 as well as the relative disposition thereof as a function of the hot environment in which the manifold 22 is to be used.

According to one embodiment, the insulation cavity 36 can be a sealed dead air cavity/pocket. The insulation cavity 36 may have a small opening for allowing very limited air circulation to avoid pressure build up inside the cavity. According to another embodiment, the insulation cavity 36 could be filled with an insulation material or an inert gas. It is also understood that more than one insulation cavity can be provided in the body 28.

Also, additional insulation layers 38 can be provided around the body 28 of each manifold segment 22a, 22b, 22c, 22d to provide additional heat insulation. It is understood that the insulation layers 38 can take various forms. For instance, a ceramic cloth and a metal foil could be wrapped around the MIM or AM created body 28 of each manifold ring segment 22a, 22b, 22c, 22d. A sheet metal shield can also be provided over the nozzle tips.

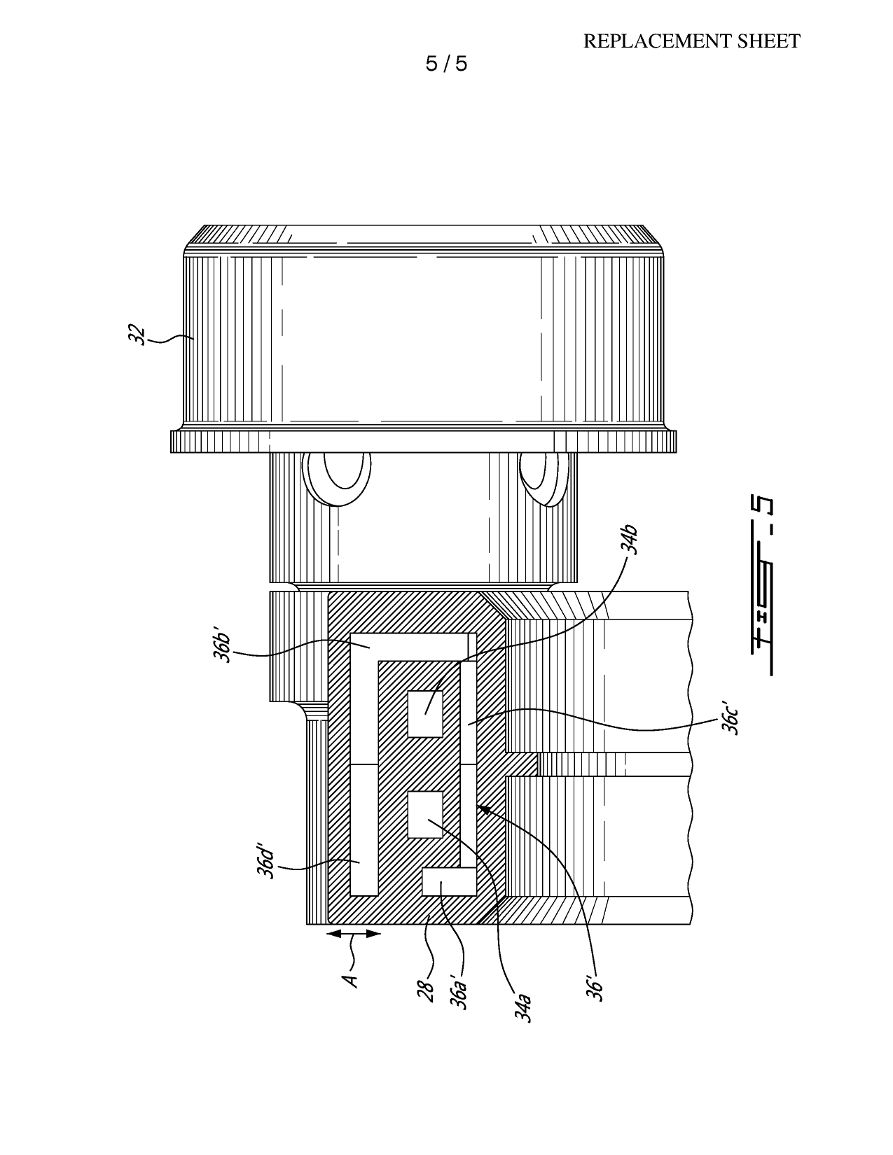

FIG. 5 illustrates an embodiment in which the insulations cavity 36′ defines an almost closed perimeter around the primary and secondary fuel channels 34a′, 34b′. The front leg 36b′ of the cavity 36 extends radially outwardly beyond the primary and secondary fuel channels 34a′, 34b′ and is connected to a “top” segment extending axially in parallel to the base segment 36c′. The “top” segment is disposed radially outwardly of the fuel channels 34a′, 34b′ to act a radially outer thermal barrier for the channels 34a′, 34b′. In this embodiment, the insulation cavity 36′ provides thermal protections on all sides of the fuel channels 34a′, 34b′. The perimeter defined by the insulation cavity around the fuel channels is interrupted at at least one location by the solid material of the monolithic body to ensure the structural integrity of the fuel manifold body. As schematically depicted by arrow A, the thickness of the manifold body 28′ may be increased at the radially outer side of the manifold to accommodate the radially outer segment of the insulation cavity 36′. The body 28′ can be a full 360 degrees ring or only a ring segment.

From the foregoing, it can be appreciated that the heat shield configuration can be optimized in terms of component shape, number of fuel passages, passage cross-section etc. In parts with complex geometries (like the herein disclosed segmented internal manifold), the use of MIM and/or AM technologies provides for the design of parts which will, in use, exhibit reduce heat input in critical areas as compared to parts obtained from conventional machining techniques. For example, the shape of the insulation feature (e.g. dead air pocket) and its location in the body 28 relative to the fuel channels 34a, 34b can be defined ignoring manufacturing limitations of the conventional machining techniques, thereby providing for an improved insulation approach. The route, shape and cross-section of the fuel channels 34a, 34b can be optimized too, which is often not the case with conventional machining techniques. The performance, weight and/or cost of fluid carrying components, such as fuel manifolds, may be improved utilizing different geometries not available via traditional casting/drilling processes.

Embodiments disclosed herein include:

A: A method of manufacturing a thermally insulated fluid carrying component comprising: using metal injection molding (MIM) or additive manufacturing (AM) to create a body having an internal insulation cavity extending along at least one fluid passage to be shielded from a heat source, the internal insulation cavity and the at least one fluid passage being eccentric to one another and to the body.

The embodiment A may have one or more of the following additional features in any combination:

Feature 1: Shaping the at least one fluid passage to have a varying cross-sectional area along a length thereof.

Feature 2: Shaping the at least one fluid passage to accelerate a flow of fluid passing therethrough.

Feature 3: Forming the fluid passage to have a convergent channel profile in a direction of flow.

Feature 4: The at least one fluid passage as at least one convergent section along a length thereof.

Feature 5: Creating a dead air cavity in the body to act as a thermal barrier to protect the at least one fuel passage.

Feature 6: Narrowing down a cross-sectional area of the at least one fluid passage in a direction of fluid flow.

Feature 7: The thermally insulated fluid carrying component is a fuel manifold of a gas turbine engine, wherein the at least one fluid passage comprises a primary fuel channel and a secondary fuel channel, and wherein the internal insulation cavity (or cavities) transversally spans both the primary fuel channel and the secondary fuel channel.

Feature 8: The internal insulation cavity has a portion spaced radially inwardly from the primary fuel channel and the secondary fuel channel relative to a central axis of the gas turbine engine.

Feature 9: Creating an asymmetric body comprises creating a ring segment or a 360 degrees manifold ring having multiple seats defined along a length thereof for receiving corresponding nozzle tips, the primary fuel channel and the secondary fuel channel being fluidly connected to the seats to deliver fuel to the nozzle tips, the primary and the secondary fuel channels narrowing down from one fuel nozzle tip to the next.

Feature 10: The internal insulation cavity has a generally U-shaped cross-section including a pair of legs projecting in a radially outward direction from an elongated base, and wherein the primary fuel channel and the secondary fuel channel are disposed between said legs, the primary fuel channel and the secondary fuel channels being thermally shielded on three sides thereof by the internal insulation cavity.

Feature 11: The insulation cavity and the at least one fuel passage have different cross-sectional shapes.

Feature 12: The body has an asymmetric cross-sectional shape.

Feature 13: Adding at least one insulation layer over the MIM or AM created body of the thermally insulated fluid carrying component.

In one further exemplary embodiment, additive manufacturing is used to create manifold 22. A number of additive manufacturing processes, such as electron beam melting (EMB), may be used. In general, additive manufacturing is a process by which a component is created by creating a plurality of stacked layers on top of one another. The layers are built directionally, and can be used to create complex shapes. For example, electron beam melting is a process by which a metal powder is deposited on a substrate or component base layer, and an electron beam is applied to select locations to melt the powder and form a first layer of the component. A new layer of metal powder is deposited, and the electron beam is applied again to melt the powder at select portions and form a second layer adjacent to the first. This process continues, layer by layer, until the desired component has been created.

Each manifold segment 22a, 22b, 22c, 22d may be constructed via a plurality of layers, each stacked on top of a previous layer to form complex shapes such as those shown in FIGS. 2-4. A benefit of this approach is that it eliminates the casting and drilling process and allows for the construction of complex geometries, including internal cavities and fuel channels geometries, not previously contemplated with respect to gas turbine engine manifolds.

Alternatively, known metal injection molding technique could be used to create the manifold segments shown in FIGS. 2-4.

The above description is meant to be exemplary only, and one skilled in the art will recognize that changes may be made to the embodiments described without departing from the scope of the invention disclosed. For example, while the invention has been described in the context of a segment fuel manifold, it is understood that the same principles are applicable to none-segmented fuel manifold designs. Also, the principles of the present invention are not strictly limited to fuel manifolds. For instance, similar principles could be applied to other fluid carrying components, such as fuel tubes, oil tubes, bearing housings just to name a few. Still other modifications which fall within the scope of the present invention will be apparent to those skilled in the art, in light of a review of this disclosure, and such modifications are intended to fall within the appended claims.

1. A fuel manifold adapted to be mounted about an axis of a gas turbine engine, the fuel manifold comprising: a monolithic body having an inner circumferential surface and an outer circumferential surface configured to extend about the axis of the gas turbine engine, at least one fuel channel integrally formed in the monolithic body, at least one insulation cavity integrally formed in the monolithic body and forming a thermal barrier radially between the at least one fuel channel and at least one of the inner circumferential surface and the outer circumferential surface.

2. The fuel manifold defined in claim 1, further comprising a plurality of nozzle tips mounted to an axially facing surface of the monolithic body between the inner circumferential surface and the outer circumferential surface, the nozzle tips being fluidly connected to the at least one fuel channel.

3. The fuel manifold defined in claim 2, wherein the at least one fuel cavity defines an open perimeter about the at least one fuel channel, a portion of the open perimeter being interrupted by a solid body portion of the monolithic body.

4. The fuel manifold defined in claim 1, wherein the at least one insulation cavity and the at least one fluid passage are eccentric to one another and to a centerline of the monolithic body.

5. The fuel manifold defined in claim 1, wherein the at least one fluid passage has a varying cross-sectional area along a length thereof.

6. The fuel manifold defined in claim 2, wherein the at least one fluid passage is configured to accelerate a flow of fuel between two adjacent ones of the nozzle tips.

7. The fuel manifold defined in claim 6, wherein the at least one fluid passage to has a convergent profile in a direction of flow, the convergent profile extending along a major portion of a length of the at least one fluid passage.

8. The fuel manifold defined in claim 1, wherein the at least one insulation cavity is a dead air cavity.

9. The fuel manifold defined in claim 1, wherein the at least one fluid passage comprises a primary fuel channel and a secondary fuel channel, and wherein the at least one insulation cavity transversally spans both the primary fuel channel and the secondary fuel channel.

10. The fuel manifold defined in claim 9, wherein the at least one internal insulation cavity has a first axially extending segment spaced radially inwardly of the primary fuel channel and the secondary fuel channel relative to a central axis of the gas turbine engine, and a second segment spaced radially outwardly of the primary fuel channel and the secondary fuel channel relative to a central axis of the gas turbine engine.

11. The fuel manifold defined in claim 10, wherein the monolithic body is a rigid ring segment having multiple seats defined along a length thereof for receiving corresponding nozzle tips, the primary fuel channel and the secondary fuel channel being fluidly connected to the seats to deliver fuel to the nozzle tips, the primary and the secondary fuel channels narrowing down from one nozzle tip to the next.

12. The fuel manifold defined in claim 11, wherein the at least one insulation cavity has a pair of legs projecting in a radially outward direction from an elongated base, and wherein the primary fuel channel and the secondary fuel channel are disposed between said legs.

13. The fuel manifold defined in claim 1, wherein the at least one insulation cavity and the at least one fuel passage have different cross-sectional shapes.

14. The fuel manifold defined in claim 11, wherein the monolithic body has an asymmetric cross-sectional shape.

15. The fuel manifold define in claim 1, wherein the fuel manifold is additive manufactured or metal injection molded as one unitary ring.

16. A method for heat shielding a fuel manifold of a gas turbine engine, the method comprising: using metal injection molding (MIM) or additive manufacturing (AM) to create an insulation cavity in an arcuate body having at least one fuel channel interconnecting a plurality of nozzle tips distributed along a length of the arcuate body, the insulation cavity having a portion thereof disposed radially inward of the at least one fuel channel relative to a center of curvature of the arcuate body to form a thermal barrier along a radially inner side of the at least one fuel channel.

17. The method as defined in claim 16, wherein the at least one fuel channel comprises a primary fuel channel and a secondary fuel channel, and wherein the insulation cavity transversally span both the primary fuel channel and the secondary fuel channel.

18. The method defined in claim 16, wherein creating the insulation cavity comprises forming a dead air cavity, the dead air cavity being eccentric relative to the arcuate body.

19. A fuel manifold for a gas turbine engine, the fuel manifold comprising: an arcuate body; nozzle seats defined in a face of the arcuate body for receiving corresponding nozzle tips, the nozzle seats being distributed along a length of the arcuate body; at least one fuel channel integrally formed in the arcuate body, the at least one fuel channel being fluidly connected to the nozzle tips; and an insulation cavity integrally formed in the arcuate body between an outer surface of the arcuate body and the at least one fuel channel.

20. The fuel manifold defined in claim 19, wherein a cross-section of the at least one fuel channel narrows down from one nozzle seat to the next.
